(19) United States
(12) Patent Application Publication
(10) Pub. No.: US 2005/0201919 A1
(43) Pub. Date: Sep. 15, 2005

(54) Materials for cathode in solid oxide fuel cells

(75) Inventors: Ho-Chieh Yu, Tainan (TW); Kuan-Zong Fung, Tainan (TW)

Correspondence Address: TROXELL LAW OFFICE PLLC, SUITE 1404, 5205 LEESBURG PIKE, FALLS CHURCH, VA, 22041, US

(73) Assignee: National Cheng Kung University

(21) Appl. No.: 10/796,976

(22) Filed: Mar. 11, 2004

(51) Int. Cl. C01F 17/00; H01M 4/86

(52) U.S. Cl. 423/263; 429/40

(57) ABSTRACT

The present invention relates to materials for cathode in solid oxide fuel cells, more particularly, an oxide having high oxygen vacancies and high conductivity as cathode, which is able to accelerate absorption of oxygen molecule and diffusion of oxygen ion for reducing internal resistance of cells, in other words, reducing overpotential of cathode, and improvement of electric generation efficiency of fuel cells. General form of the cathode materials is Ln₁₋ₓAₓCu_{1-y}B_{y}O_{2.5±δ}, wherein Ln is lanthanide ion, A is alkaline-earth metal, B is metal. Cathode dope different alkaline-earth metal on A side to converse partly copper (Cu) to trivalence copper ion for forming perovskite having oxygen vacancies with regularity sequence, by utilizing catalytic of cathode electrode accelerating cathode reaction and compound electron being conducted though external circuit with conversing oxygen to form oxygen ion for obtaining anode and hydrogen reaction by diffusing oxygen ion to electrolyte.

### FIELD OF THE INVENTION

The present invention relates to materials for cathode in solid oxide fuel cells (SOFCs). More particularly, the invention relates to an oxide having high oxygen vacancies and high conductivity as cathode which is able to accelerate absorption of oxygen molecule and diffusion of oxygen ion.

### DESCRIPTION OF THE RELATED ART

A fuel cell is an electrochemical cell in which converts the energy of a chemical reaction into electricity by promoting a chemical reaction between two gases. It differs from a battery in that the fuel and oxidant are stored external to the cell, which can generate power as long as the fuel and oxidant are supplied. A typical fuel cell consists of a fuel electrode (anode) and an oxidant electrode (cathode), separated by an ion-conducting electrolyte. The electrodes are connected electrically to a load (such as an electronic circuit) by an external circuit conductor. In the circuit conductor, electric current is transported by the flow of electrons, whereas in the electrolyte it is transported by the flow of ions, such as the hydrogen ion (H⁺) in acid electrolytes, or the hydroxyl ion (OH⁻) in alkaline electrolytes. A fuel capable of chemical oxidation is supplied to the anode and ionizes on a suitable catalyst to produce ions and electrons. Gaseous hydrogen is the fuel of choice for most applications, because of its high reactivity in the presence of suitable catalysts and because of its high energy density. Similarly, an oxidant is supplied to the fuel cell cathode and is catalytically reduced. The most common oxidant is gaseous oxygen, which is readily and economically available from the air for fuel cells used in terrestrial applications. When gaseous hydrogen and oxygen are used as a fuel and oxidant, the electrodes are porous to permit the gas-electrolyte junction to be as great as possible. The electrodes must be electronic conductors, and posses the appropriate reactivity to give significant reaction rates. Since the electrolyte is a non-electronic conductor, the electrons flow away from the anode via the external circuit. At the cathode, oxygen reacts with the hydrogen ions migrating through the electrolyte and the incoming electrons from the external circuit to produce water as a byproduct. The byproduct water is typically extracted as vapor. The overall reaction that takes place in the fuel cell is the sum of the anode and cathode reactions, with part of the free energy of reaction released directly as electrical energy and the remainder as heat.

The study of fuel cell in Taiwan, PEM Fuel Cell is the earliest research. Further researches are Direct Methanol Fuel Cell (DMFC) and solid oxide fuel cells (SOFCs). A fuel cell system in which methanol is supplied in liquid form to the fuel cells is called as Direct Methanol Fuel Cell (DMFC) system. DMFC is applied as power source for small-sized 3′c electric product.

In recent applications of fuel cell, there are five types consisting of Alkaline Fuel (AF) Proton Exchange Membrane PEM phosphoric acid PA molten carbonate MC and solid oxide SO. Alkaline fuel cell is mainly applied in universe plan, while phosphoric acid is mostly used as fuel in application of generating power in power-station. Because of solid oxide fuel cells having advantages such as low-cost, high efficiency, using natural gas as fuel, low pollution level, fastest development, therefore, becomes mostly being applied by electric power company in United States. According to research data of auto-mobile motive research centre, fuel cell mobile will be step into fist stage on 2005 to 2010. If evaluated by recent market, depends to a total sold sum having 56000 thousands cars were sold on 1999, thereby, predict on 2020, inferential market of fuel cell mobile in global scale will attach 14000 thousands mobiles, wherein are mainly being concentrated at satellite cities such as New York, Massachusetts, Washington about 6000 thousands mobiles, 4000 thousands in Japan, 4000 thousands mobiles in Middle Europe and North Europe.

A solid oxide fuel cell is an energy conversion device that produces direct-current electricity by electrochemically reacting a gaseous fuel (e.g., hydrogen) with an oxidant (e.g., oxygen) across an oxide electrolyte. The key features of current SOFC technology include all solid-state construction, multi-fuel capability, and high-temperature operation. Because of these features, the SOFC has the potential to be a high-performance, clean and efficient power source and has been under development for a variety of power generation applications.

Under typical operating conditions, an SOFC single cell produces less than 1V. Thus, for practical applications, single cells are stacked in electrical series to build voltage. Stacking is provided by a component, referred to as an interconnection that electrically connects the anode of one cell to the cathode of the next cell in a stack. Conventional SOFCs are operated at about 1000 degree Celsius and ambient pressure.

A SOFC single cell is a ceramic tri-layer consisting of an oxide electrolyte sandwiched between an anode and a cathode. The conventional SOFC materials are yttria-stabilized zirconia (YSZ) for the electrolyte, strontium-doped doped lanthanum manganite (LSM) for the cathode, nickel/YSZ for the anode, and doped lanthanum chromite for interconnection. Currently, there are two basic cell constructions for SOFCs: electrolyte-supported and electrode-supported.

In an electrolyte-supported cell, the electrolyte is the mechanical support structure of the cell, with a thickness typically between 150 and 250 m. Electrolyte-supported cells are used, for example, in certain planar SOFCs designs. In an electrode-supported cell, one of the electrodes (i.e., the anode or cathode) is the support structure. The electrolyte is a thin film that the thickness is not greater than 50 m is formed on the support electrode. Tubular, segmented-cells-in-electrical-series and certain planar SOFCs designs, employ this type of cell.

By using combination of SOFC with turbine, efficiency of generating power can be achieved in the range of 70% to 80%, therefore, fuel cell will be the important application in development of generating power system.

Component of related material comprises of Proton Exchange Membrane (PEM), nafion solution, catalyst, electrode, gaseous expanding layer, bipolar plate and other key material. Key assembly comprises of membrane electrode assembly (MEA), fuel cell stack, recombine machine and the others. Apparatus of fuel cell system comprises of system controller, hydrogen storage container, effective air-pressing machine, heat converter, temperature controlling box, source converter and motor.

Most of the conventional cathode materials have perovskite such as La₁₋ₓAₓMn_{1-y}B_{y} wherein the A material is selected from the group consisting of Sr, Ca, and Ba, and the B material is selected from the group consisting of Co, Fe, and Ni. Compound temperature of the conventional cathode materials is about 1200 degrees Celsius, and anneal temperature in fabrication of solid oxide fuel cells is about 1400 degrees Celsius. Therefore, if using perovskite as cathode materials, not only failed to improve performance of fuel cells, but also failed to reduce productive cost of cells. Furthermore, because of limitation of oxygen vacancies in this cathode material, therefore, diffusion of oxygen ion is not easily available and is to form easily a higher internal resistance which producing wastage of internal power. Although cathode materials which is using now have high electric conductivity, problem of insufficient conductivity of oxygen ions exist commonly. Therefore, cathode materials now are unable to provide efficient high temperature oxide fuel cells.

### SUMMARY OF THIS INVENTION

The main purpose of the present invention is to provide materials for cathode in solid oxide fuel cells (SOFCs), more particularity, an oxide having high oxygen vacancies and high conductivity as cathode, the cathode is able to accelerate absorption of oxygen molecule and diffusion of oxygen ion that means to reduce overpotential of cathode and to increase efficiency of power generation of fuel cells.

Another purpose of the present invention is to form a cathode material having high electric conductivity, also, a large sum of oxygen vacancies is provided in the cathode material as cathode reaction site and diffusion way of oxygen ions, as a result of lower over potential in the cathode material and reducing of compound temperature of the cathode material.

For the above purpose of materials for cathode in solid oxide fuel cells according to the present invention, the materials have a general form as Ln₁₋ₓAₓCu_{1-y}B_{y}O_{2.5±δ}, wherein Ln is a lanthanide ion, A is alkaline-earth metal, B is metal. Doping different alkaline-earth metal on A side, followed by conversing partly copper (Cu) to trivalence copper ion to form perovskite having oxygen vacancies with regularity sequence. And then, by using catalytic to accelerate cathode reaction of cathode electrode, compound electron being conducted through external circuit with conversing oxygen to forming oxygen ion, finally, anode and hydrogen reaction is obtained by diffusing oxygen ion to electrolyte. By the above steps, by using cathode materials in solid oxide fuel cells having advantages of accelerating absorption of oxygen molecule and diffusion of oxygen ion, comprising effects of descending resistance inside cells, in other words, means that reduce overpotential of cathode and further increase efficiency of electricity generation of fuel cells.

The cathode materials have excellent electric conductivity and high oxygen vacancies as reaction site and diffusion way of oxygen ion, to form cathode materials having a lower overpotential and reducing compound temperature, which accelerates absorption of oxygen molecule and diffusion of oxygen ion, means to reduce overpotential of cathode, further to increase efficiency of power generation of fuel cells.

### BRIEF DESCRIPTION OF THE DRAWINGS

The present invention will be better understood from the following detailed description of preferred embodiments of the invention, taken in conjunction with the accompanying drawings, in which

FIG. 1 is a graph showing electric conductivity mass of La₁₋ₓSrₓCuO_{2.5±δ} according to the present invention; and

FIG. 2 is a graph showing cathodic overpotential of cathode according to the present invention.

### DESCRIPTION OF THE PREFERRED EMBODIMENTS

The following descriptions of the preferred embodiments are provided to understand the features and the structures of the present invention.

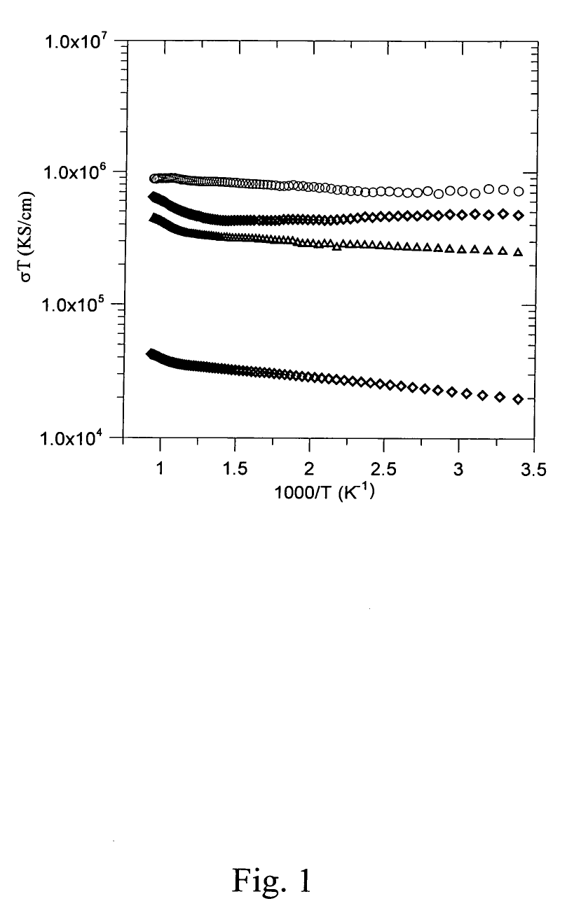

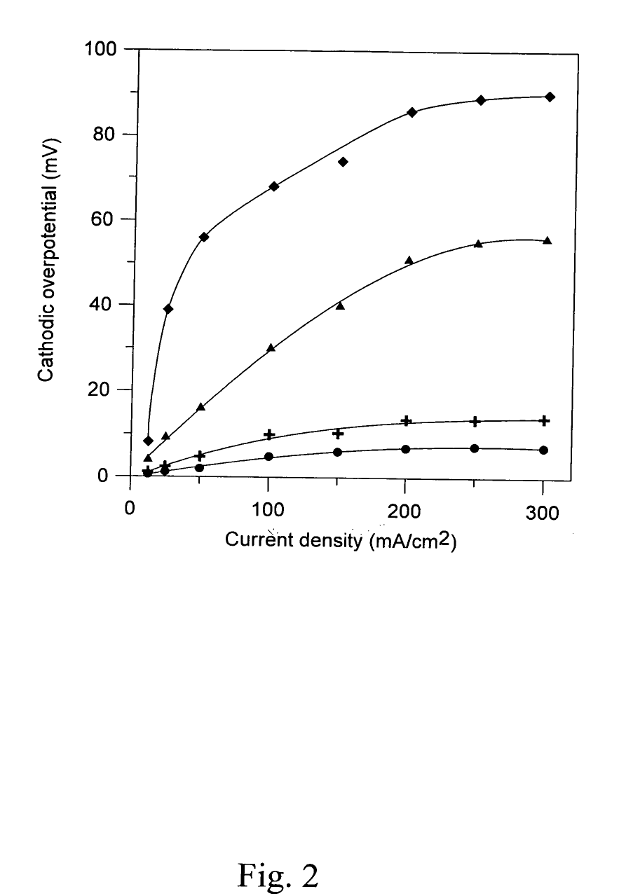

Please refer to FIG. 1, is a graph showing electric conductivity mass of La₁₋ₓSrₓCuO_{2.5±δ} according to the present invention, and FIG. 2 is a graph showing cathode of cathodic overpotential according to the present invention. The present invention relates to materials for cathode in solid oxide fuel cells (SOFCs), the cathode uses an oxide having high oxygen vacancies and high conductivity for accelerating absorption of oxygen molecule and diffusion of oxygen ion to descend resistance inside cells, in other words, means that reduce overpotential of cathode, further increasing efficiency of electricity generation of fuel cells. The materials for cathode are alkaline-earth metal ions doping by lanthanum (La) and copper (Cu) oxide, which is perovskite oxide having oxygen vacancies with regularity sequence and general form as ABO_{2.5±δ}.

The cathode material of general form according to the present invention is Ln₁₋ₓAₓCu_{1-y}B_{y}O_{2.5±δ,} and operating temperature is in a range of 400-800 degrees Celsius. Ln is lanthanide ion and is selected from the group consisting of lanthanum (La), cerium (Ce), praseodymium (Pr), neodymium (Nd), promethium (Pm), stannum (SN), europium (Eu), gadolinium (Gd), terbium (Tb), dysprosium (Dy), holmium (Ho), erbium (Er), thulium (Tm), ytterbium (Yb) and lutetium (Lu). A is alkaline-earth metal, which is selected from the group consisting of beryllium (Be), magnesium (Mg), calcium (Ca), strontium (Sr), barium (Ba) and radium (Ra). B is metal, which is selected from the group consisting of cobalt (Co), iron (Fe), nickel (Ni), zinc (Zn), manganese (Mn), aluminum (Al), vanadium (V), iridium (Ir), molybdenum (Mo), palladium (Pd), platinum (Pt), magnesium (Mg), ruthenium (Ru), rhodium (Rh), chromium (Cr) and zirconium (Zr). Moreover, X is greater than or equal to 0 and less than or equal to 1, Y is greater than or equal to 0 and less than 0.99, 6 is greater than or equal to 0 and less than or equal to 0.5. The materials comprise at least 1% copper (Cu), and dope different alkaline-earth metal on A side, for conversing partly copper (Cu) to trivalence copper ion, to form perovskite having oxygen vacancies with regularity sequence, this structure is known as Brownmillerite. But, component of this structure is tiny, therefore, controlling of doping amount and types of different ions is necessary needed exactly.

By using catalytic of cathode electrode to accelerate cathode reaction, compounds electron are conducted though external circuit with conversing oxygen to forming oxygen ion for obtaining anode and hydrogen reaction by diffusing oxygen ion to electrolyte. Therefore, the present invention disclose materials of cathode having high electrical conductivity and conducting oxygen ions can be further developed and optimized as materials for cathode.

Electrochemistry analysis such as amount of electron conductivity and overpotential analysis according to cathode materials are showing in FIG. 1 an FIG. 2. FIG. 1 is a graph showing electric conductivity of La₁₋ₓSrₓCuO_{2.5±δ} when x 0.15 Δ x 0.2 ⋄ x 0.25 ◯ x 0.3. FIG. 2 is a graph showing cathodic overpotential curve of the cathode when La_{0.7}Sr_{0.3}CuO_{2.5±δ}, separately measure in temperature of 600(♦), 700(▴), 800( ) and 900(●) degree Celsius.

From said FIG. 1 and FIG. 2, the materials have high electron conductivity, better overpotential and small internal resistance. The characteristics are useful to achieve efficiency at conductivity of fuel cells and reduce internal wastage when power generating. An oxide having high oxygen vacancies and high conductivity is used as cathode, wherein the cathode accelerates absorption of oxygen molecule and diffusion of oxygen ion, in another words, achieves to reduce over potential of cathode, further to increase electric conductivity of fuel cells. The cathode materials have excellent electric conductivity, oxygen ion conductivity and high oxygen ion vacancy, to provide many reaction site on surface of materials. Based on reasons stated above, this material may be an excellent material for cathode in solid oxide fuel cells. According to this present invention is to provide the cathode materials and yttrium (Y) for stable zirconium oxide as electrolyte, and by using platinum as electrode to form monocell. Then by using external circuit method to simulate internal resistance wastage of tested electrode, and measure overpotential when power on, overpotential at 800 degrees Celsius according to the present invention is better than cathode material La₁₋ₓSrₓMnO₃ (LSM) of conventional method. Therefore, efficiency of high temperature oxide fuel cells according this material for cathode electrode is improved. Besides working efficiency, comparison between compound temperature of LSM as 1200 degrees Celsius and 950 degrees Celsius of the present invention is present.

Furthermore, in the fabrication of solid oxide fuel cells, using this materials as cathode, a lower anneal temperature as 850 degrees Celsius of this present invention is presented when comparison is made with anneal temperature of LSM/YSZ as 1200 degrees Celsius. Therefore, using lanthanum strontium copper oxide which having oxygen vacancies perovskite as cathode materials, except can improve functions of fuel cells, also can reduce production cost of cells.

The present invention may be embodied in other specific forms without departing from the spirit of the essential attributes thereof; therefore, the illustrated embodiment should be considered in all respects as illustrative and not restrictive, reference being made to the appended claims rather than to the foregoing description to indicate the scope of the invention.

1. Materials for cathode in solid oxide fuel cells (SOFCs), comprising:
an oxide having oxygen vacancies and high conductivity as cathode, wherein cathode accelerating absorption of oxygen molecule and diffusion of oxygen ion; said materials having general form as Ln₁₋ₓAₓCu_{1-y}B_{y}O_{2.5±δ}, wherein Ln is lanthanide ion, A is alkaline-earth metal, B is metal, X is greater than or equal to 0 and less than or equal to 1, Y is greater than or equal to 0 and less than 0.99, δ is greater than or equal to 0 and less than or equal to 0.5; and doping different alkaline-earth metals to said A, conversing partly copper (Cu) to trivalence copper ion, forming perovskite having oxygen vacancies with regularity sequence, utilizing catalytic accelerating cathode reaction of cathode electrode, compounding electron being conducted though external circuit with conversing oxygen to forming oxygen ion obtaining anode and hydrogen reaction by diffusing oxygen ion to electrolyte.

2. The materials according to claim 1, wherein said materials comprise at least 1% copper (Cu).

3. The materials according to claim 1, wherein lanthanum (La) is selected from the group consisting of cerium (Ce), praseodymium (Pr), neodymium (Nd), promethium (Pm), stannum (SN), europium (Eu), gadolinium (Gd), terbium (Tb), dysprosium (Dy), holmium (Ho), erbium (Er), thulium (Tm), ytterbium (Yb) and lutetium (Lu).

4. The materials according to claim 1, wherein said alkaline-earth metal is selected from the group consisting of beryllium (Be), magnesium (Mg), calcium (Ca), strontium (Sr), barium (Ba) and radium (Ra)

5. The materials according to claim 1, wherein said metal is selected from the group consisting of cobalt (Co), iron (Fe), nickel (Ni), zinc (Zn), manganese (Mn), aluminum (Al), vanadium (V), iridium (Ir), molybdenum (Mo), palladium (Pd), platinum (Pt), magnesium (Mg), ruthenium (Ru), rhodium (Rh), chromium (Cr) and zirconium (Zr).

6. The materials according to claim 1, wherein said Ln₁₋ₓAₓCu_{1-y}O_{2.5±δ} is operating temperature in a range of 400-800 degrees Celsius.

7. The materials according to claim 1, wherein said materials for cathode is the ABO_{2.5±δ}.
